(19) United States
(12) Patent Application Publication
(10) Pub. No.: US 2014/0279263 A1
(43) Pub. Date: Sep. 18, 2014

(54) SYSTEMS AND METHODS FOR PROVIDING PRODUCT RECOMMENDATIONS

(71) Applicant: TrueCar, Inc., Santa Monica, CA (US)

(72) Inventors: Xingchu Liu, Austin, TX (US); Isaac Lemon Laughlin, Los Angeles, CA (US); Mikhail Semeniuk, Golden Valley, MN (US); Michael D. Swinson, Santa Monica, CA (US)

(73) Assignee: TrueCar, Inc., Santa Monica, CA (US)

(21) Appl. No.: 14/054,509

(22) Filed: Oct. 15, 2013

Related U.S. Application Data
(60) Provisional application No. 61/778,903, filed on Mar. 13, 2013.

(51) Int. Cl. G06Q 30/06

(52) U.S. Cl. CPC G06Q 30/0627
USPC 705/26.63

(57) ABSTRACT

Systems, methods and computer program products for providing recommendations to consumers, where the recommendations are based on determinations of similarity between desired products and recommended products. In one embodiment, a system includes a server computer coupled to a network and a data store. The server computer receives from client devices user input that identifies the characteristics of a desired product. The data store contains a plurality of product listings. For each of a set of these listings, the server computer identifies characteristics of the listed product, and compares characteristics of the listed product to characteristics of the desired product. The server computer determines similarity measures for the individual characteristics, and determines an overall similarity score for the listed product based on the similarity measures for the individual characteristics. The server computer orders the listed products based on the similarity scores, and provides a recommendation output to the user.

### CROSS-REFERENCE TO RELATED APPLICATION(S)

This is a conversion of, and claims a benefit of priority from U.S. Provisional Application No. 61/778,903, filed Mar. 13, 2013, entitled, “SYSTEM AND METHOD FOR PROVIDING VEHICLE RECOMMENDATIONS,” which is fully incorporated by reference herein.

### TECHNICAL FIELD

This disclosure relates generally to recommending products in a marketplace. More particularly, embodiments disclosed herein relate to systems, methods, and computer program products for providing recommendations to shoppers of high value items such as vehicles.

### BACKGROUND OF THE RELATED ART

Consumers who wish to purchase high value items such as automobiles have increasing amounts of information that may aid their search for desired items, but the amount of information that is available, and the typically raw state of the information may cause it to be more overwhelming to consumers than it is helpful.

For example, when a consumer shops for an automobile, he or she may access many different websites that have information on the features and prices of the different models that are available. It may be necessary to access a number of different websites to access information on different makes and models that the consumer may be considering. Typically, it is up to the consumer to sift through all of the information on these websites and to try to make sense of the information. This task can be daunting when the consumer is shopping for a new automobile, and it becomes even more so when shopping for a used automobile, because the available choices become less uniform. For example, not all models may be available, and the available models may have widely varying features, mileages, etc.

Some websites may provide tools to help consumers analyze the information that is available. These tools may, for instance, include recommendation engines. Typically, these recommendation engines implement a form of collaborative filtering. Collaborative filtering makes use of consumers' browsing and/or purchasing histories to identify relationships between products. For example, consumers who viewed product A ultimately purchased product B. Thus, if a consumer views product A, the recommendation engine may recommend product B to the consumer. This recommendation, however, does not address any particular interests or concerns of the consumer to whom it is provided, but only directs the consumer to follow the actions of previous consumers, who may have had completely different interests and concerns.

It would therefore be desirable to provide means to better tailor recommendations that are provided to a particular consumer to the specific interests and concerns of that particular consumer.

### SUMMARY OF THE DISCLOSURE

This disclosure is directed to systems, methods and computer program products for providing recommendations to consumers, where the recommendations are based on determinations of similarity between desired products and recommended products.

One embodiment is a system for providing product recommendations to users. The system includes a server computer which is coupled to a network, and a local data store that is accessible by the server computer. The server computer is configured to receive user input from client devices via the network. The user input identifies the characteristics of a desired product, such as a new or used automobile. The data store contains a plurality of product listings. For each of a set of these listings, the server computer identifies characteristics of the listed product, and compares characteristics of the listed product to characteristics of the desired product. The server computer determines similarity measures for the individual characteristics, and then determines an overall similarity score for the listed product based on the similarity measures for the individual characteristics. The server computer orders the listed products based on the similarity scores, and provides a recommendation output to the user through the client device. The recommendation output ranks one or more of the listed products based on the corresponding similarity scores.

In one embodiment, the server computer is configured to determine an n-gram weighting factor for each of the product listings. The n-gram weighting factor indicates a probability with which the characteristics of the product listing occur in the plurality of product listings, and is used by the server computer to adjust the similarity score for the listed product. The server computer may be configured to compare the listed price for each product to an expected price for the product and determine a value score based upon a relationship between the listed and expected prices (e.g., expected price divided by listed price). The Value score may be used to order the listings before they are output to the user. The server computer may be configured to convert non-numeric representations characteristics to corresponding numeric representations. The server computer may map multiple, distinct non-numeric representations of a first characteristic to a single numeric representation of the first characteristic. These numeric representations can be used to determine the similarity score for each of the listed products by computing, for one or more of the characteristics, a numeric difference between a value of the characteristic for desired product and a value of the characteristic for the listed product. In one embodiment, the server computer associates a distinct weight with each of the characteristics and determines the similarity score based on the products of the numeric differences and associated weights. These weights may be modified in response to user input (e.g., explicit input or input which is implicit from the user's behavior).

An alternative embodiment comprises a method for providing product recommendations to users. In this method, a server computer receives user input from one or more client devices via a network, where the user input identifies characteristics of a desired product. The server computer then retrieves a set of product listings from a data store. For each of the plurality of product listings retrieved from the local data store, characteristics of a corresponding listed product are identified, and the characteristics of the listed product are compared to the characteristics of the desired product. Similarity measures are separately determined for the different characteristics, and an overall similarity score for the listed product is determined based on the similarity measures for the individual characteristics. The listed products are based on the similarity scores, and a recommendation output is provided to the user via the client device.

Another alternative embodiment comprises a computer program product. The computer program product uses a computer-readable storage medium to store computer instructions that are executable to perform a method in which user input identifying characteristics of a desired product is received from one or more client devices. A set of product listings is retrieved from a data store and, for each of the listings, characteristics of a corresponding listed product are identified. The characteristics of the listed product are then compared to the characteristics of the desired product. Similarity measures are separately determined for the different characteristics, and an overall similarity score for the listed product is determined based on the similarity measures for the individual characteristics. The listed products are based on the similarity scores, and a recommendation output is provided to the user via the client device.

Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 depicts a flow diagram illustrating a method for providing vehicle recommendations according to an embodiment disclosed herein;

FIG. 2 depicts one embodiment of a topology including a vehicle data system in accordance with one embodiment;

FIG. 3 depicts a flow diagram of an exemplary method for providing product recommendations to consumers in accordance with one embodiment;

FIG. 4 depicts a flow diagram illustrating a method for determining the similarity of two vehicles based on their individual characteristics in accordance with one embodiment; and

FIG. 5 depicts a flow diagram illustrating an exemplary method for ordering product listings by value in accordance with one embodiment.

### DETAILED DESCRIPTION

The invention and the various features and advantageous details thereof are explained more fully with reference to the non-limiting embodiments that are illustrated in the accompanying drawings and detailed in the following description. Descriptions of well-known processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard disk (HD)), hardware circuitry or the like, or any combination.

Before discussing specific embodiments, a brief overview of the context of the disclosure may be helpful. Embodiments disclosed herein provide systems, methods, and computer program products for recommending items (typically high value items such as new and used vehicles) to consumers. Recommendations that are individualized and tailored to a consumer may be determined by evaluating similarities between products. The similarities between the products may be evaluated at different levels. For instance, at a high level, similarities between automobiles may be determined based on body style or price. At a lower, more detailed level, similarities may be determined based on specific features or characteristics of the automobiles, such as navigation systems or mileage. Different features or characteristics may be weighted so that they have differing amounts of impact on an overall similarity score between products.

In one embodiment, a consumer accesses a recommendation system via a network such as the internet. The consumer provides some initial input as to the type of product for which he or she wishes to have a recommendation. For instance, the consumer might specify a particular model of automobile, or a type of automobile and a price range. The system may be configured to initially use a set of predetermined factors and weights which are used to evaluate the similarity of a set of product listings to the input provided by the consumer. Based on the system's evaluation of the similarities, it may order the product listings (e.g., from most similar to least similar) and present the ordered listings to the consumer. The consumer's review of the presented listings may provide additional input from which the system can better determine the features and characteristics that are most important to the consumer. For example, if the consumer only reviews listings for automobiles that have navigation systems, the recommendation system may increase the weight of the component of the similarity metric associated with navigation systems.

The specific exemplary embodiments of the invention described herein will be directed to vehicle data systems that are presented to consumers via websites on the Internet. Those skilled in the art will recognize that, although the items presented to the consumers in these examples are vehicles, these embodiments are illustrative and non-limiting examples. Alternative embodiments may be implemented in other systems and may be used to recommend other types of high value items.

Referring to FIG. 1, a flow diagram illustrating one example embodiment for providing vehicle recommendations to a user searching for a new or used vehicle is shown. In some embodiments, at step 102, a vehicle data system may receive a vehicle configuration or trim from a user's computing device which is communicatively connected to the vehicle data system through a network. At step 104, the vehicle data system may operate to determine similarities between listings of available vehicles, as described in more detail below. At step 106, the vehicle data system may operate to determine recommendations based on the similarities of the listings and present these recommendations to the user at the user's computing device.

In some embodiments, methods for providing vehicle recommendations to a visitor of a website may include determining the similarity of one or more pairs of vehicles based on the “trim” of each vehicle. Within this disclosure, a “trim” refers to a set of observable characteristics, attributes, or features that can be used to describe a vehicle. Non-limiting example features may include drive, vehicle segment, etc. Also within this disclosure, the terms “trim” and “vehicle configuration” may be used interchangeably. Again, the invention disclosed herein is not limited to providing vehicle recommendations and may be adapted for providing recommendations for other types of items. Accordingly, an embodiment of a method for providing recommendations to shoppers of an item or items may include determining an item similarity for every pair of items of a plurality of items in a data store. In some embodiments, the determining may include, for each pair of items of a plurality of items, computing an individual feature differences between two items, and computing a composite similarity between the two items.

A new vehicle may be manufactured and sold in a variety of different trims. It may therefore be useful or desirable to determine similarities for each pair of the different trims. The similarity determinations may be performed by a vehicle data system and may be stored in a data store (data storage device) that is accessible by the vehicle data system. In determining the similarity of two vehicles, individual features associated with the trims may be weighted. The weights may be obtained, assigned, and/or optimized in various ways. One approach is to obtain weights from experts in the field. A feature considered to be more important than other features in determining an item similarity may be given a higher weight. Accordingly, in one embodiment, predetermined weights can be assigned to individual features. Another approach to obtain weights may be data-driven. More specifically, optimal weights may be estimated based on online behavior of users. For example, in one embodiment, a collaborative filtering technique may be employed to train a statistical model based on web traffic data. Web traffic data may include, for each user, the user's browsing history and what features of which item have been viewed by the user. Yet another approach may combine weights assigned by experts and weights estimated using data. For example, in one embodiment, assigned weights may be used where data is scarce or insufficient.

Individual features can be transformed from essentially descriptive words (e.g., “the color is yellow”) into numeric values. Various descriptive words may also be combined, or mapped to the same characteristic. For example, “yellow”, “canary” and any other names for various shades of yellow may all be treated as the same color, and may be converted to the same numeric representation. Furthermore, any difference between the features can be quantified, measured, weighted, and combined.

In one embodiment, for each pair of items, a percentage/probability of users who browse both items can be derived and used to compute a similarity score representing a relative similarity between two items. For example, suppose a user has not viewed vehicles #1, #2, #3, has viewed vehicles #4, and is interested in vehicle #5. The probability of users who browsed vehicle #5 and also vehicles #1, #2, #3, and #4 can be used to determine a similarity score between each pair—#1 and #5, #2 and #5, #3 and #5, and #4 and #5. This allows recommendations to be made even if a user has never seen a certain recommended item or items before. In one embodiment, the more similar the two items, the higher the similarity score. The similarity score can then be used to make recommendations.

The recommendations thus determined may be presented or otherwise communicated to a user in various ways. For example, suppose four vehicles #1, #2, #3, and #4 are determined to be similar to vehicle #5 as follows:

| | Similarity Score |
|---|---|
| Vehicle # | Relative to Vehicle 5 |
| Vehicle 1 | 0.1 |
| Vehicle 2 | 0.6 |
| Vehicle 3 | 0.2 |
| Vehicle 4 | 0.999 |

In this example, a list of recommendations may be presented to the user in order of similarity as follows: vehicle #4, vehicle #2, vehicle #3, and vehicle #1. In some cases, it may be desired to shorten the list of recommendations. To do so, a threshold or percentage may be applied. For example, a list of recommendations configured to show only those vehicles having a similarity score of 50% or more may include just vehicle #4 and vehicle #2. Other ways to present recommendations may also be possible. The recommendations may be communicated to users via a website, emails, or some other communication means.

The above-described methodology can provide a solution for identifying similar trims (“trim similarity”), which is useful for recommending similar new cars. To identify similar used cars for sale (“listing similarity”), additional factors may need to be considered. One reason is that, unlike new cars, used cars cannot be manufactured in response to demand. Thus, even for the same trim, the used cars that are available may vary greatly in mileage, age, and/or condition. Accordingly, inventory can be a factor in determining a similarity between two listings of used vehicles.

Furthermore, because inventory may be low, similar used cars may be distributed across geographical locations, and may not be available in some locations. Accordingly, location can be another factor in determining a similarity between two listings of used vehicles. In one embodiment, listing similarity may be determined in part based on the similarity of the respective geographical locations of the listings. In another embodiment, listing similarity may be determined within a geographical boundary. As a non-limiting example, a geographical boundary may be defined as a 50-mile driving distance from a location. Such a geographical boundary may be determined depending upon a user preference or preferences. For instance, a user may be willing to travel from Baltimore to San Francisco to buy a particular used vehicle while another user may be willing to compromise on a feature and buy another similar used car that does not have the particular feature but that is available for sale locally. These two examples show that users may have different sensitivity levels with respect to products themselves and proximity of such products relative to the users. Those skilled in the art will recognize that, applied broadly, trim similarity may also be determined within a geographical boundary. As another non-limiting example, a geographical boundary may be defined to include the entire United States.

In some embodiments, a similarity between any given two listings may be determined in consideration of a plurality of factors including trim similarity, inventory level, geographical boundary, etc. The plurality of factors may be weighted to achieve a business goal such as to improve sales. For example, after users submitted leads to a website for listings of items, a vehicle data system implementing an embodiment disclosed herein may recommend to the users listings that are similar to those to which they submitted leads and that may improve sales and increase the revenue for an operator of the vehicle data system.

In some embodiments, the methodology employed in determining a listing similarity can be the same or similar to the methodology employed in determining a trim similarity. In some embodiments, the set of used vehicles in inventory for which a listing similarity needs to be computed may be limited to increase computational efficiency.

The various embodiments of the recommendation systems disclosed herein can be implemented in hardware systems having many different topologies. FIG. 2 depicts one particular topology which may be used to implement embodiments of the systems and methods disclosed herein. Topology 200 comprises a set of entities including vehicle data system 220 (also referred to herein as the TrueCar system) which is coupled through network 270 to computing devices 210 (e.g., computer systems, personal data assistants, kiosks, dedicated terminals, mobile telephones, smart phones, etc.), and one or more computing devices at inventory companies 240, original equipment manufacturers (OEM) 250, sales data companies 260, financial institutions 282, external information sources 284, departments of motor vehicles (DMV) 280 and one or more associated point of sale locations, in this embodiment, car dealers 230a . . . n. Computing devices 210 may be used by consumers while conducting a search for consumer goods and/or services, such as automobiles. Network 270 may be for example, a wireless or wired communication network such as the Internet or wide area network (WAN), publicly switched telephone network (PTSN) or any other type of electronic or non-electronic communication link such as mail, courier services or the like.

Vehicle data system 220 may comprise one or more computer systems with central processing units executing instructions embodied on one or more computer readable media where the instructions are configured to perform at least some of the functionality associated with embodiments disclosed herein. These applications may include a vehicle data application 290 comprising one or more applications (instructions embodied on one or more non-transitory computer readable media) configured to implement an interface module 292, data gathering module 294 and processing module 296 utilized by the vehicle data system 220. Furthermore, vehicle data system 220 may include data store 222 operable to store obtained data 224, data 226 determined during operation, models 228 which may comprise a set of dealer cost model or price ratio models, or any other type of data associated with embodiments disclosed herein or determined during the implementation of those embodiments.

Vehicle data system 220 may provide a wide degree of functionality, including utilizing one or more interfaces 292 configured to, for example, receive and respond to queries from users at computing devices 210; interface with inventory companies 240, manufacturers 250, sales data companies 260, financial institutions 282, DMVs 280 or dealers 230 to obtain data; or provide data obtained, or determined, by vehicle data system 220 to any of inventory companies 240, manufacturers 250, sales data companies 260, financial institutions 282, DMVs 280, external data sources 284 or dealers 230. It will be understood that the particular interface 292 utilized in a given context may depend on the functionality being implemented by vehicle data system 220, the type of network 270 utilized to communicate with any particular entity, the type of data to be obtained or presented, the time interval at which data is obtained from the entities, the types of systems utilized at the various entities, etc. Thus, these interfaces may include, for example, web pages, web services, a data entry or database application to which data can be entered or otherwise accessed by an operator, or almost any other type of interface which it is desired to utilize in a particular context.

In general, then, using these interfaces 292 vehicle data system 220 may obtain data from a variety of sources, including one or more of inventory companies 240, manufacturers 250, sales data companies 260, financial institutions 282, DMVs 280, external data sources 284 or dealers 230 and store such data in data store 222. This data may be then grouped, analyzed or otherwise processed by vehicle data system 220 to determine desired data 226 or models 228 which are also stored in data store 222.

A user at computing device 210 may access the vehicle data system 220 through the provided interfaces 292 and specify certain parameters, such as a desired vehicle configuration or incentive data the user wishes to apply, if any. The vehicle data system 220 can select a particular set of data in the data store 222 based on the user specified parameters, process the set of data using processing module 296 and models 228, generate interfaces using interface module 292 using the selected data set on the computing devices 210 and data determined from the processing, and present these interfaces to the user at the user's computing device 210. Interfaces 292 may visually present the selected data set to the user in a highly intuitive and useful manner.

A visual interface may present at least a portion of the selected data set as a price curve, bar chart, histogram, etc. that reflects quantifiable prices or price ranges (e.g., “average,” “good,” “great,” “overpriced,” etc.) relative to reference pricing data points (e.g., invoice price, MSRP, dealer cost, market average, internet average, etc.). Using these types of visual presentations may enable a user to better understand the pricing data related to a specific vehicle configuration. Additionally, by presenting data corresponding to different vehicle configurations in a substantially identical manner, a user can easily make comparisons between pricing data associated with different vehicle configurations. To further aid the understanding for a user of the presented data, the interface may also present data related to incentives which were utilized to determine the presented data or how such incentives were applied to determine presented data.

Turning to the various other entities in topology 200, dealers 230a . . . n may include a retail outlet for consumer goods and/or services, such as vehicles manufactured by one or more of OEMs 250. To track or otherwise manage sales, finance, parts, service, inventory and back office administration needs, a dealer may employ a dealer management system (DMS) (e.g., DMS 232a . . . n). Since many DMSs are Active Server Pages (ASP) based, transaction data (transaction data 234a . . . n) may be obtained directly from the DMS with a “key” (for example, an ID and Password with set permissions within the DMS system) that enables data to be retrieved from the DMS. Many dealers may also have one or more web sites which may be accessed over network 270, where pricing data pertinent to the dealers may be presented on those web sites, including any pre-determined, or upfront, pricing. This price is typically the “no haggle” price (i.e., price with no negotiation) and may be deemed a “fair” price by vehicle data system 220.

Inventory companies 240 may be one or more inventory polling companies, inventory management companies or listing aggregators which may obtain and store inventory data from one or more of dealers 230a . . . n (for example, obtaining such data from DMS 232a . . . n). Inventory polling companies are typically commissioned by the dealer to pull data from a DMS and format the data for use on websites and by other systems. Inventory management companies manually upload inventory information (photos, description, specifications) on behalf of the dealer. Listing aggregators get their data by “scraping” or “spidering” websites that display inventory content and receiving direct feeds from listing websites (for example, AutoTrader.com, FordVehicles.com, etc.).

DMVs 280 may collectively include any type of government entity to which a user provides data related to a vehicle. For example, when a user purchases a vehicle it must be registered with the state (for example, DMV, Secretary of State, etc.) for tax and titling purposes. This data typically includes vehicle attributes (for example, model year, make, model, mileage, etc.) and sales transaction prices for tax purposes.

Financial institution 282 may be any entity such as a bank, savings and loan, credit union, etc. that provides any type of financial services to a participant involved in the purchase of a vehicle. For example, when a buyer purchases a vehicle they may utilize a loan from a financial institution, where the loan process usually requires two steps: applying for the loan and contracting the loan. These two steps may utilize vehicle and consumer information in order for the financial institution to properly assess and understand the risk profile of the loan. Typically, both the loan application and loan agreement include proposed and actual sales prices of the vehicle.

Sales data companies 260 may include any entities that collect any type of vehicle sales data. For example, syndicated sales data companies aggregate new and used sales transaction data from DMSs of particular dealers. These companies may have formal agreements with certain dealers that enable them to retrieve data from the dealers in order to syndicate the collected data for the purposes of internal analysis or external purchase of the data by other data companies, dealers, and OEMs.

Manufacturers 250 can be those entities which actually build the vehicles sold by dealers 230a . . . n. To guide the pricing of their vehicles, manufacturers 250 may provide an Invoice price and a Manufacturer's Suggested Retail Price (MSRP) for both vehicles and options for those vehicles—to be used as general guidelines for the dealer's cost and price. These fixed prices are set by the manufacturer and may vary slightly by geographic region.

External information sources 284 may comprise any number of other various source, online or otherwise, which may provide other types of desired data, for example data regarding vehicles, pricing, demographics, economic conditions, markets, locale(s), consumers, etc.

It should be noted here that not all of the various entities depicted in topology 200 are necessary, or even desired, in embodiments disclosed herein, and that certain of the functionality described with respect to the entities depicted in topology 200 may be combined into a single entity or eliminated altogether. Additionally, in some embodiments other data sources not shown in topology 200 may be utilized. Topology 200 is therefore exemplary only and should in no way be taken as imposing any limitations on embodiments disclosed herein.

Referring to FIGS. 3-5, an exemplary method for providing product recommendations to consumers in accordance with one embodiment is illustrated. Referring first to FIG. 3, the vehicle data system initially receives information from a consumer identifying a vehicle configuration (302). This information may be very general, or more specific. For instance, the consumer may identify a particular make, model and year for a desired vehicle, or the consumer may identify specific characteristics such as mileage, location, color, accessories, and the like. Alternatively, the user may select a particular vehicle listing, which may itself identify characteristics of the listed vehicle.

Based upon the information provided by the consumer, the vehicle data system compares the characteristics of the desired or target vehicle to the characteristics associated with a set of vehicle listings and determines a measure of the similarity of each of the vehicles in these listings to the target vehicle (304). In one embodiment, the vehicle listings are stored in data store 222, and a similarity determination is made between the target vehicle and each of the stored listings. In another embodiment, the system may limit the similarity determinations to a particular subset of the listings in the data store (e.g., those within a specified number of miles of the consumer's location).

After the similarity determinations have been made for the appropriate set of vehicle listings, the system selects one or more of the listings to be presented to the consumer (306). The number of listed presented may range from a single listing (representing the most similar vehicle), to a subset of the listings (e.g., the top five most similar listings), to the entire set of listings. The selected listings are ordered appropriately (308) and are presented to the consumer through a user interface (310). The listings may be ordered by similarity (e.g., starting with the most similar and continuing in order of decreasing similarity), price, value, proximity to the consumer, or other attributes.

As noted above, the vehicle data system makes comparisons of the characteristics of the target vehicle to those of the vehicle listings to determine the similarity of each pair (304). The similarity between two vehicles may be determined for a consumer in a variety of ways, such as tracking which vehicles were viewed by previous consumers, or by making comparisons of individual characteristics of the vehicles. Referring to FIG. 4, a flow diagram illustrating a method for determining the similarity of two vehicles based on their individual characteristics is shown.

In the example of FIG. 4, the individual characteristics that comprise the trim of each vehicle are quantified (402). For characteristics such as mileage, the characteristic is already in numeric form, and these values may be used as-is, or they may be converted into normalized values. In the case of non-numeric information, the system may convert the information into numeric values to facilitate comparisons between vehicles. For instance, specific vehicle colors may be assigned corresponding values, or assessments of body condition (e.g., “poor”, “fair”, “good”) may be converted to corresponding numeric values (e.g., 0.2, 0.5 and 0.8, respectively).

Using the numeric values of the characteristics, the similarity of each individual characteristic is then determined (404). In one embodiment, this determination is simply a computation of the difference between the values associated with the characteristic. In other embodiments, the computation may be more complex. For instance, if the target vehicle has an overall condition assessment of “fair”, a vehicle listing that has a condition of “good” may be evaluated as more similar than one that has a condition which is “poor”, even though the differences between the numeric representations of the conditions are the same.

In this embodiment, the similarity determinations for the individual characteristics are weighted (406), and the weighted similarity values are aggregated to arrive at an overall similarity measure for the pair of vehicles being considered (408). The weighting factor for each characteristic is multiplied by the similarity value for that characteristic to adjust the impact of the characteristic's similarity on the overall similarity measure. For instance, the characteristic of body condition may be given more weight than color. In one embodiment, the weights are initially set based on expert input, but the weights are adjusted in response to implicit or explicit feedback from the consumer. For example, if the consumer only views listings that include a navigation system, the navigation system characteristic may be more heavily weighted in the overall similarity determination.

As noted above, after the similarities of the vehicle listings are determined, the listings are ordered for presentation to the consumer. While the listings may be ordered in many different ways, such as by similarity or by price, one of the ways that may be most useful to the consumer is to order similar listings by value. “Value”, as used here is distinct from “price”. The price of the listed vehicle is simply the price at which the vehicle can be purchased. The price alone, however, may not indicate the greatest bargain for the consumer. For example, the listings may include two vehicles that are identical, except that the first listing has a navigation system and the second one does not. If the first listing has a price which is one dollar more than the second listing, it does not have the lowest price, but it does have the greatest value—for one more dollar, the consumer can have a navigation system that may be worth hundreds of dollars.

Referring to FIG. 5, an exemplary method for ordering product listings by value is depicted. For the purposes of this example, “value” will be defined as the expected price divided by the actual price. As shown in FIG. 3, a set of listings that will be presented to the consumer are first selected (306). For each of the listings in this set, an expected value is determined (502). In the case of new vehicles, the expected price may be the manufacturer's suggested retail price (MSRP). In the case of used vehicles, the expected price may be determined from conventional sources that identify used vehicle pricing (e.g., the Kelley Blue Book, or Edmunds.com), or using methods such as those disclosed in U.S. patent application Ser. No. 13/967,148, filed Aug. 14, 2013, entitled “SYSTEM, METHOD AND COMPUTER PROGRAM FOR FORECASTING RESIDUAL VALUES OF A DURABLE GOOD OVER TIME,” which is incorporated by reference as if set forth herein in its entirety.

An actual listed price is also identified for each of the listings (504). The value of each listing is then determined based on a comparison of the expected and actual prices (506). In one embodiment, the value is determined by dividing the expected price by the actual price, but alternative embodiments may use other methodologies for computing the value. The set of similar listings are then ordered according to their values (508) and are presented to the consumer.

Example embodiments will now be described in more detail below with respect to a trim similarity approach and a listing similarity approach. Trim similarity computations can be performed independent of inventory, and are useful for identifying new cars that are similar to each other. Listing similarity computations can consider additional factors such as inventory, and thus can be useful for identifying used cars that are similar to each other.

Every distinct vehicle trim has a set of m observable characteristics, attributes, or features (collectively referred to herein as “features”) that can be used to describe it. Example features may include:
model year
market average price
miles per gallon (MPG)
transmission
horsepower
drive
body type
engine size
color
vehicle segment

For purpose of clustering or classifying trims into known groups, a 1-dimensional metric can be used to determine how similar trims are to one another. For example, a 2009 Ford Mustang GT convertible may be more similar to a 2008 Ford Mustang GT convertible (or 2009 Ford Mustang GT hard top) than a 2005 Chevrolet Silverado. A single, 1-dimensional similarity metric can be built for every pair of trims (i and j) for which comparisons might be made. This is further explained below.

Notation. An item, xᵢ, can be described by its p=1, . . . m features (also known as characteristics or variables):

xᵢ={x_{i,1},x_{i,2}, . . . ,x_{i,m}}

and all n distinct items may be represented in matrix form as

$$X = [ \begin{matrix}{x}_{1 , 1} & {x}_{1 , 2} & … & {x}_{1 , m - 1} & {x}_{1 , m} \\ {x}_{2 , 1} & {x}_{2 , 2} & … & {x}_{2 , m - 1} & {x}_{2 , m} \\ ⋮ & ⋮ & ⋱ & ⋮ & ⋮ \\ {x}_{n - 1 , 1} & {x}_{n - 1 , 2} & … & {x}_{n - 1 , m - 1} & {x}_{n - 1 , m} \\ {x}_{n , 1} & {x}_{n , 2} & … & {x}_{n , m - 1} & {x}_{n , m}\end{matrix} ]$$

Although the format of the data for some options may not be numeric, similarity can still be established across features by first transforming the data to a numeric scale.

Binary Features. When the possible states that a feature may assume is only two (e.g., yes/no, on/off, black/white, etc.), it is fairly simple to map this onto a numeric scale by setting one state to 1 and the other to 0. For example, the following rule could be applied to transform a feature represented as “yes”/“no” onto a numeric scale:

if x_{i,p}=“yes” then x_{i,p}=1
if x_{i,p}=“no” then x_{i,p}=0

The choice of which state is assigned the value of 1 is unimportant, as it does not affect the similarity computations in the filter.

Ordinal Features. When the values of a feature takes on a non-numeric format with an implied order (e.g., “Low”/“Medium”/‘“High”, “Poor”/“‘Fair”/“Good”) a simple transformation would represent the features using their ranks. For example, the following rule could be applied to transform a feature represented as “low”/“medium”/“high” onto a numeric scale:

if x_{i,p}=“low” then x_{i,p}=1
if x_{i,p}=“medium” then x_{i,p}=2
if x_{i,p}=“high” then x_{i,p}=3.

More complex transformations may be applied if there is information that indicates the need to non-uniformly space the various states.

Categorical Features. When the values of a feature takes on a non-numeric format without an implied order (e.g., “Red”/“White”/“Green”), similarity for that feature across observations can still be established, but it is more simple to leave this data as-is until a later stage of the filter. If there are only two states that the feature may assume, one could also just consider the feature to be binary.

The similarity (sᵢⱼ) among item xᵢ and xⱼ based on a comparison of p observable features can be computed using the Minkowski metric:

sᵢⱼ=1−[Σₚ₌₁^{m}wₚ|x_{i,p}−x_{j,p}|^{λ}]^{1/λ}

where
λ≧0, 0≦sᵢⱼ≦1, and Σₚ₌₁^{m}wₚ=1

If the features are categorical, (e.g., red/white/green), then |x_{i,p}=x_{j,p}|=0 if the categories match, and 1 otherwise.

Example: If we let λ=2 and let wₚ=0.5 for the price feature (p=1), 0.2 for the fuel efficiency feature, 0.1 for the turbo feature (p=3), and 0.3 for the color feature (p=4) and so Σₚ₌₁^{m}wₚ=1. The similarity between vehicle 1 and vehicle 2 is computed as follows:

Step 1: Compute individual feature difference between observations i and j:

Price:|x_{i,1}−x_{j,1}|=|x_{1,price}−x_{2,price}|=|0.8−0.0|=0.8

Fuel Efficiency:|x_{i,2}−x_{j,2}|=x_{1,fuel eff}−x_{2,fuel eff}|=|0.5−0.0|=0.5

Turbo:|x_{i,3}−x_{j,3}|=|x_{1,turbo}−x_{2,turbo}|=|1.0−0.0|=1.0

Color:|x_{i,4}−x_{j,4}|=|x_{1,color}−x_{2,color}|=(blue≠red)=1.0

Step 2: Compute composite similarity between observations i and j:

sᵢⱼ=1−[Σₚ₌₁^{m}wₚ|x_{i,p}−x_{j,p}|^{λ}]^{1/λ}=1−[0.5×(0.8)²+0.2×(0.5)²+0.1×(1.0)²+0.3×(1.0)²]^{1/2}=1−(0.77)^{1/2}=0.051

Step 3: Repeat for all possible values of i and j.

To estimate w and λ, web traffic data can be used as the training dataset. Web traffic data stores the trims and each user's browsing history. Thu, for each pair of trims, a percentage/probability p of users who browse both trims can be derived. A logistic regression can be applied:

$$p = \frac{1}{1 + {e}^{α - β {S}_{ij}}}$$

Once w and λ are estimated, a similarity score sᵢⱼ can be derived and perhaps scaled to a value between 0 and 1. In this case, the higher the similarity score, the more similar the trims may be with respect to their observable features.

A specific example will now be described.

Example: Suppose the filter were to be applied to an automobile purchase in the “midsize car” category for which there were three vehicle types, each having four features {price, fuel efficiency, turbo, color} as shown in Table 1.

TABLE 1
Vehicle Feature Set

| | | Fuel Efficiency | Turbo | Color |
|---|---|---|---|---|
| Vehicle | Price (numeric) | (Ordinal) | (Binary) | (Categorical) |
| 1 | $26,000 | Medium | Yes | Blue |
| 2 | $18,000 | Low | No | Red |
| 3 | $28,000 | High | Yes | Blue |

The transformation to the numeric scale (except the categorical features) would yield the results shown in Table 2.

TABLE 2
Numerically-scaled Vehicle Feature Set

| | | Fuel Efficiency | Turbo | Color |
|---|---|---|---|---|
| Vehicle | Price (numeric) | (Ordinal) | (Binary) | (Categorical) |
| 1 | $26,000 | 2 | 1 | Blue |
| 2 | $18,000 | 1 | 0 | Red |
| 3 | $28,000 | 3 | 1 | Blue |

All features that have been transformed to a numeric format can then be represented on a scale bounded over [0,1] as follows:

$${x}_{i , p} = \frac{( {x}_{i , p} - {min}_{i} {x}_{, . p} )}{( {max}_{i} {x}_{. , p} - {min}_{i} {x}_{. , p} )}$$

Example: Suppose the filter were to be applied to an automobile purchase in the “midsize car” category and the least expensive car in the category was $18,000 and the most expensive car in the category was $28,000. The scaled values of the price feature for the least expensive, most expensive, and a car in the category that cost $26,000 would be:

least expensive: Xi,p=(18,000−18,000)/(28,000−18,000)=0/10,000=0.0
most expensive: Xi,p=(28,000−18,000)/(28,000−18,000)=10,000/10,000=1.0

### $26,000 car: Xi,p=(26,000−18,000)/(28,000−18,000)=8000/10,000=0.8

The standardized numeric representation of the features is shown in Table 3.

TABLE 3
Standardized Numeric Vehicle Feature Set

| | | Fuel Efficiency | Turbo | Color |
|---|---|---|---|---|
| Vehicle | Price (numeric) | (Ordinal) | (Binary) | (Categorical) |
| 1 | 0.8 | 0.5 | 1.0 | Blue |
| 2 | 0.0 | 0.0 | 0.0 | Red |
| 3 | 1.0 | 1.0 | 1.0 | Blue |

An example of a methodology for determining listing similarity will now be described.

For used cars listings, location can be a factor in determining similarity, in addition to trim features. In some cases, the calculation of listing similarity may need to serve a business goal such as to improve sales. One way is to maximize probability of users submitting leads. Those skilled in the art will recognize that the methodology described herein can be easily applied to serve other business purposes. As an example, after users submit leads for listings to vehicle data system 220, vehicle data system 220 may operate to contact the users and recommend listings similar to the ones that they submit leads to.

Example factors that may be considered in determining listing similarity may include the following:
zip code
driving distance (e.g., from an address or locale in a search query)
mileage
inventory level (e.g., counts of the same models)
census data
rank of listing
page of listing
competitiveness of listing price

To collect data to improve the determination of listing similarity, a model such as one implementing the trim similarity approach described above may initially be used to recommend listings of used cars to users. The recommendations and user responses may be recorded and used as training data. For each recommended listing, an indicator may be derived using leads. For example, a value of 1 may indicate that a user submits the lead for the listing and 0 may indicated that the user does not submit the lead. A logistic regression can then be applied:

$$p = \frac{1}{1 + {e}^{α - β {S}_{ij} - γ {L}_{ij}}}$$

where Lᵢⱼ represents the listing attributes of recommended listing j to users who submit leads to listing i.

Once α,β, γ are estimated, a similarity score can be derived for any given two listings.

These listings may be provided by disparate sources including dealerships, private parties, etc. Accordingly, the listings may not have standardized descriptions. For example, one listing may list the year, make, model, color, mileage, and general condition of a used car, while another listing may include a detailed description on all the observable features of a used car. As described above, a system implementing the trim similarity computation may determine, for a given vehicle (for instance, as identified by the vehicle's unique identification number or VIN), a one-to-one mapping between a known trim and a 1-dimensional similarity metric. Accordingly, listings with varying descriptions can present a challenge in determining a similarity score.

To this end, in some embodiments, a method of determining a listing similarity may include processing each listing from a natural language processing perspective. More specifically, in addition to the trim similarity computation, a similarity coefficient and an n-gram weighting factor may be computed. As an example, a similarity coefficient may be computed as follows:

$${T}_{ϕ , i , j} = 1 - \frac{{\sum }_{ϕ = 1}^{n} ( {L}_{ϕ , i} == True \& {L}_{ϕ , j} == True )}{\begin{matrix}{\sum }_{ϕ}^{n} ( {L}_{ϕ , i} == True ) + {\sum }_{ϕ}^{n} ( {L}_{ϕ , j} == True ) - \\ {\sum }_{ϕ = 1}^{n} ( {L}_{ϕ , i} == True \& {L}_{ϕ , j} == True )\end{matrix}}$$

where
T_{φ,i,j}=Tanimoto score
φ=unique words from set of vehicle features (make, model, style, options)
Lᵢ=Listing i

The Tanimoto score has been used in machine learning as known to those skilled in the art. The n-gram weighting factor is a new method for adjusting the Tanimoto score.

The n-gram weight is essentially a factor that indicates how meaningful is a Tanimoto score, and, more specifically, how rare is this combination of listing descriptions (i.e., how often can a match be found with a high score). It is also used to calibrate how restrictive cut-offs should be, given a similarity score between two vehicles described in the listings.

To compute the n-gram weight, a data vehicle system implementing an embodiment disclosed herein may obtain all the vehicle descriptions from the universe of current listings, for instance, all the listings from a data store accessible by the data vehicle system. The data vehicle system may build a document based on the obtained vehicle descriptions. As an example, each line of the document can be a description for each unique vehicle as follows (number=vehicle id):

1. <p>2012 BMW 3-Series Coupe 335i Automatic Transmission Heated Seats Navigation System
2. <p>2011 BMW 3-Series Convertible 328i Automatic Transmission Navigation System
3. . . .

For each vehicle listed in the document, the data vehicle system may compute a probability score representing a probability of another vehicle with a similar description (i.e., how likely it is to find, in the universe of all the listings (N), a vehicle that is similar to the given vehicle). The probabilities for a varying number of N in an n-gram can be computed. As a specific example, suppose N=2, a Bi-Gram probability for the first vehicle in the above sample document can be computed as follows:

P(2012|<p>)=0.13. This translates to: 13% of the records have “2012” following the start of the description.
P(BMW|2012)=0.067. This translates to: 6.7% of the cases have the word “BMW” following “2012”.

The probability score is computed for each term in the description. The probability score for the entire description can be computed as:

P=Σ log(P(Termᵢ|Termᵢ₋₁)

This process is done for every vehicle listed in the document. At this point, a similarity score between each pair of vehicle i and vehicle j is determined. Also determined is a probability score representing how likely it is to find vehicle i out of the universe of all the listings. These scores can be used in determining a list of vehicle recommendations.

For example, given a distribution of probabilities, each listing can be classified as being common or non-common in discrete terms. Then, based on discrete cut-offs, a decision can be made about the similarity score and Tanimoto score as to which can be classified as similar or not similar. Those skilled in the art will appreciate that embodiments disclosed herein can be configured to present vehicle recommendations in virtually unlimited ways. One example is to set a threshold with respect to the similarity score and show vehicles with similarity scores meeting or exceeding the threshold. Another example is to set a threshold with respect to the number of vehicles found to be similar. Yet another example is to use both and show a certain number of vehicles with similarity scores meeting or exceeding a threshold.

Because there may be many used vehicle listings in a geographical boundary (e.g., a country) and calculating the pairwise similarity of any two listings may be computationally difficult, it can be useful to limit the set of vehicles in inventory for which the similarity needs to be computed. Such limits can be constructed such that they affect vehicles which the similarity score is likely to be too low to warranted recommendations. For example, a limit might be set with respect to the maximum distance from a customer that a recommendation would be made to the customer. As a result, any vehicle that is located further than the maximum distance from the customer would not be recommended to the customer even if that vehicle was exactly identical to another vehicle the customer had expressed interest in. Various user-configurable parameters may be implemented. For example, the following characteristics may be used to limit the set of vehicles for which it is necessary to compute similarities:
Listing Price
Make
Vehicle Type
Color
Mileage

Additionally, limits can be determined by analyzing the behavior of previous customers (e.g., users of vehicle data system 220). For example, it may be determined that the benefit of increased speed (one benefit for example is that recommendations can be prepared and presented to the consumer faster) warrants a loss of only 1% of sales. Using historical customer data, the maximum distance travelled by the customers to purchase vehicles may be determined. A limit can be set by an administrator for the system to automatically exclude only the top 1% of sales by customer-distance travelled.

Another difference between new car and used car customers is that used car customers may represent a wider range of consumer preferences. Whereas a new car shopper's preferences can vary across a range of prices and available vehicle features, a used car customer's preference can additionally vary with respect to mileage, condition and age. Furthermore, a used car customer may have to be more compromising on the make, model, color or other vehicle characteristics since, if their preferred vehicle is unavailable, it is unlikely that the vehicle can be special ordered. Because of the complexity of users' preferences, it may be advantageous to cluster users into different profiles.

In the context of an embodiment of a data vehicle system disclosed herein, a user can reveal their preferences through their behavior on the site. For example, one user may search for a specific year, make, model, and color, and may specify a narrow mileage range, whereas another user may search for only a particular body-style and age with an upper limit on price. Using historical data about similar customers, these users may be clustered to distinct profiles—for instance, vehicle-sensitive and price-sensitive profiles. Different profiles may have different coefficients applied to the vehicle similarity score described above. For example, the system may recommend a vehicle farther away from the first user if it matches the preferences revealed in their searches, whereas the system may recommend a good-value vehicle nearby to the second user.

Agglomerative clustering can be a suitable way to construct clusters for in settings such as this used-car search behavior example. Using features describing a user's behavior, such as how many vehicles they have looked at, the price range of vehicles considered, the number of colors considered, etc. the customers can be analyzed and grouped with other similar customers. An agglomerative clustering approach seeks to describe which two users are closest to one another. These two users are assigned to a group. The algorithm can iteratively assign either individual users, or groups of users into larger groups (again based on their closeness) until a single group has been constructed. There are a number of ways to define a distance between two clusters called A and B below, which will result in different clusters. As an example, a complete-linkage method uses the distance metric,

max{d(a,b)for aΣA,bΣB}

where d is the distance metric used to calculate distance between two points, such as Euclidean distance.

This method calculates the distance between two groups as the maximum distance between any of their two individual points. Using domain expertise, the hierarchy of clusters can be examined and attributed to one of the expected profiles mentioned above. Note that the number of clusters is not pre-determined in this approach. Thus, it is possible for this approach to reveal unanticipated clusters.

Once the users have been clustered, they can be treated separately in terms of what vehicles are recommended to them. By allowing analyzing the effectiveness independently, tests of competing algorithms are allowed to have different outcomes and can arrive at different optimums for each group. Accordingly, a system implementing an embodiment disclosed herein may recommend similarly priced vehicles to some groups and more similarly featured vehicles to others.

Embodiments disclosed herein can provide many advantages. For example, a system implementing an embodiment of a method disclosed herein may leverage similarity between users and/or their browsing behaviors and similarity between items (products) themselves to recommend similar items in a meaningful, relevant manner. Furthermore, in addition to making relevant recommendations (relevant with respect to an item and a potential purchaser of the item), the system can be configured to serve a business goal of improving sales to thereby increase the revenue for an operator of the system.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylist, touch pad, etc.), or the like.

ROM, RAM, and HD are computer memories for storing computer-executable instructions executable by the CPU or capable of being complied or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” or is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used, individually or in conjunction with another programming language, to implement the routines, methods or programs of embodiments of the invention described herein, including C, C++, Java, JavaScript, HTML, or any other programming or scripting language, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise. The scope of the present disclosure should be determined by the following claims and their legal equivalents.

What is claimed is:

1. A system for providing product recommendations to users, the system comprising:
a server computer coupled to a network; and
a local data store coupled to the server computer;
wherein the server computer is configured to:
receive user input from one or more client devices via the network, wherein the user input identifies one or more characteristics of a desired product;
for each of a plurality of product listings stored in the local data store, identifying one or more characteristics of a corresponding listed product, comparing the one or more characteristics of the listed product to the one or more characteristics of the desired product, separately determining similarity measures for the one or more characteristics, and determining a similarity score for the listed product based on the similarity measures for the one or more characteristics;
ordering the listed products based on the similarity scores; and
providing a recommendation output to the client device, wherein the recommendation output ranks one or more of the plurality of listed products based on the corresponding similarity scores.

2. The system of claim 1, wherein the server computer is further configured to, for each of the plurality of product listings, determine an n-gram weighting factor indicating a probability with which the characteristics of the product listing occur in the plurality of product listings, and adjust the similarity score for the listed product according to the n-gram weighting factor.

3. The system of claim 1, wherein the server computer is further configured to, for each of the plurality of product listings, compare a price associated with the product listing to an expected price for the product listing and determine a value score based upon a relationship between the price associated with the product listing and the expected price for the product listing.

4. The system of claim 3, wherein the server computer is configured to order the listed products in the recommendation output based at least in part on the value scores for the product listings.

5. The system of claim 1, wherein the server computer is configured to convert non-numeric representations characteristics to corresponding numeric representations.

6. The system of claim 5, wherein the server computer determines the similarity score for each of the listed products by computing, for one or more of the characteristics, a numeric difference between a value of the characteristic for desired product and a value of the characteristic for the listed product.

7. The system of claim 6, wherein the server computer associates a distinct weight with each of the characteristics and determines the similarity score based on the products of the numeric differences and associated weights.

8. The system of claim 7, wherein the server computer is configured to modify one or more of the weights in response to input from a user.

9. The system of claim 1, wherein the server computer is configured to map multiple, distinct non-numeric representations of a first characteristic to a single numeric representation of the first characteristic.

10. A method for providing product recommendations to users, the method comprising:
a server computer receiving user input from one or more client devices via a network, wherein the user input identifies one or more characteristics of a desired product;
the server computer retrieving a plurality of product listings from a data store;
for each of the plurality of product listings retrieved from the local data store, identifying one or more characteristics of a corresponding listed product, comparing the one or more characteristics of the listed product to the one or more characteristics of the desired product, separately determining similarity measures for the one or more characteristics, and determining an overall similarity score for the listed product based on the similarity measures for the one or more characteristics;
ordering the listed products based on the similarity scores; and
providing a recommendation output to the client device, wherein the recommendation output ranks one or more of the plurality of listed products based on the corresponding similarity scores.

11. The method of claim 10, further comprising, for each of the plurality of product listings, determining an n-gram weighting factor indicating a probability with which the characteristics of the product listing occur in the plurality of product listings, and adjusting the similarity score for the listed product according to the n-gram weighting factor.

12. The method of claim 10, further comprising, for each of the plurality of product listings, comparing a price associated with the product listing to an expected price for the product listing, determining a value score based upon a relationship between the price associated with the product listing and the expected price for the product listing, and ordering the listed products in the recommendation output based at least in part on the value scores for the product listings

13. The method of claim 10, further comprising converting non-numeric representations characteristics to corresponding numeric representations and determining the similarity score for each of the listed products by computing, for one or more of the characteristics, a numeric difference between a value of the characteristic for desired product and a value of the characteristic for the listed product

14. The method of claim 13, further comprising associating a distinct weight with each of the characteristics, wherein one or more of the weights are modified in response to input from a user, and determining the similarity score based on the products of the numeric differences and associated weights.

15. A computer program product comprising at least one non-transitory computer-readable storage medium storing computer instructions that are translatable by a processor to perform:
receiving user input which identifies one or more characteristics of a desired product;
retrieving a plurality of product listings from a data store;
for each of the plurality of product listings retrieved from the local data store, identifying one or more characteristics of a corresponding listed product, comparing the one or more characteristics of the listed product to the one or more characteristics of the desired product, separately determining similarity measures for the one or more characteristics, and determining an overall similarity score for the listed product based on the similarity measures for the one or more characteristics;
ordering the listed products based on the similarity scores; and
providing a recommendation output to the client device, wherein the recommendation output ranks one or more of the plurality of listed products based on the corresponding similarity scores.

16. The computer program product of claim 15, further comprising, for each of the plurality of product listings, determining an n-gram weighting factor indicating a probability with which the characteristics of the product listing occur in the plurality of product listings, and adjusting the similarity score for the listed product according to the n-gram weighting factor.

17. The computer program product of claim 15, further comprising, for each of the plurality of product listings, comparing a price associated with the product listing to an expected price for the product listing, determining a value score based upon a relationship between the price associated with the product listing and the expected price for the product listing, and ordering the listed products in the recommendation output based at least in part on the value scores for the product listings.

18. The computer program product of claim 15, further comprising converting non-numeric representations characteristics to corresponding numeric representations and determining the similarity score for each of the listed products by computing, for one or more of the characteristics, a numeric difference between a value of the characteristic for desired product and a value of the characteristic for the listed product.

19. The computer program product of claim 18, further comprising associating a distinct weight with each of the characteristics, wherein one or more of the weights are modified in response to input from a user, and determining the similarity score based on the products of the numeric differences and associated weights.
